(19) United States
(12) Patent Application Publication
(10) Pub. No.: US 2008/0260371 A1
(43) Pub. Date: Oct. 23, 2008

(54) Patent application for an apparatus and method of positioning a flash on a camera

(76) Inventor: Jerry Curtis Hughes, Austin, TX (US)

Correspondence Address: Jerry Hughes, 5521 Greenville Avenue, PMB 104-732, Dallas, TX, 75206, US

(21) Appl. No.: 11/788,790

(22) Filed: Apr. 20, 2007

(51) Int. Cl. G03B 15/03

(52) U.S. Cl. 396/155

(57) ABSTRACT

This invention allow a photographer to quickly and easily flip their on camera flash to a vertical position when taking a vertical photograph using a hinge that allows it to tilt to the left and right with wiring to transfer information between the flash and camera. The invention can be built into a flash or a separate device. This eliminates the need for a bracket and off camera flash cord cost, storage space in camera bag, and bulkiness when taking photos.

### BACKGROUND OF INVENTION

When taking photos with a flash mounted on top of a camera, keeping the flash above the lens is known to create more pleasing light in photography. Taking photos with the camera in the horizontal position the flash is both above and directly over the lens creating pleasing light. When the camera is moved from a horizontal position to a vertical camera position, this repositions the flash so it is no longer above the lens and the lighting does not look as good. The flash is also farther from the lens which creates larger shadows behind the subject which is also less desirable.

A flash bracket is generally the current method used to reposition the camera or the flash to keep the flash above the lens in both horizontal and vertical photos. Flash brackets are expensive, take a lot of space in a camera bag, and can be unwieldy to use. They also do not allow the flash to swivel or tilt for bounce flash capabilities to allow flashes that do not have that feature built into them.

When taking vertical photographs some photographers prefer to hold the camera with their hand under the camera body and some prefer to hold the camera with their hand on top of the camera body. Brackets rarely offer both choices.

Being able to change the side of the camera that the flash is on to be opposite a second flash or natural light source helps balance the light on the subject.

When using a flash bracket a TTL cord is needed to connect the camera to the flash and communicate information between them to control the flash output and camera exposure. TTL cords are expensive, take more space in the bag and the cord can get in the way when adjusting the flash bracket. It is also unprotected and can snag and get pulled on damaging the cord.

What is needed is a simple device that quickly repositions the flash above the lens when changing the camera from horizontal to vertical, allows more swivel and tilt positions, transmits TTL information between the camera and the flash, fits in your pocket, allows positioning the flash on left or right of camera in vertical position, a choice of camera grip positions, and works with light modifiers.

### SUMMARY OF THE INVENTION

This invention allows a photographer to quickly and easily flip their flash to a vertical position when the camera is in a vertical position to keep the flash above the lens for better lighting and closer to it for less shadow behind the subject. It quickly flips back for horizontal camera position photos to keep the flash above the lens. It eliminates the need for expensive brackets and off camera cords. The device built into the flash it takes no space, as a separate device it takes very little space in a camera bag compared to a bracket and off camera cord. It weighs less and is less obtrusive than a bulky bracket and cord. Being able to flip the flash to the left or right above the camera also allows the photographer to choose how they hold the camera with their hand under it or over it with the shutter button up or down with the camera position. It also allows more swivel and tilt positions when the camera is in the vertical position for different bounce flash angles off ceilings and walls. A built in swivel hinge allow swivel to flashes that don't have built in swivel.

### BRIEF DESCRIPTION OF THE DRAWINGS

FIG. 1a The camera 23H, in horizontal position with attached flash 20, above lens 22, in vertical position.

FIG. 1b The camera 23V, in vertical position with attached flash 20, to side of lens 22, in horizontal position.

FIG. 2a The camera 23H, in horizontal position with flash flip 24, and attached flash 20, above lens 22, in vertical position.

FIG. 2b The camera 23V, in vertical position with flash flip 24, tilted 90 degrees right and attached flash 20, above lens 22, in vertical position.

FIG. 3a The flash in a side view.

FIG. 3b The flash in a side view divided into pieces with the flash foot 29, separated from the flash body and the hinge between the flash body and flash head separated.

FIG. 3c The flash hinge with a flash foot on the bottom and hot shoe on the top.

FIG. 4 The back of the hinge with the flash foot and hot shoe attached tilted to the side with a release button and swivel plates.

FIG. 5 The front of the hinge with the flash foot and hot shoe attached tilted to the side with upper and lower swivel plates.

FIG. 6 The flash flip device with an upward facing hinge.

FIG. 7 The flash flip device with an downward facing hinge.

FIG. 8 Flash flip 24, with shoe and electrical receivers 28, attached to tightening wheel 27, and bottom swivel 34, with swivel release button 33. Outer casing with hinge 25, and release button connected to top swivel 32, with swivel button release 33, and hot shoe 30, on top.

FIG. 9 Flash flip 24, with shoe and electrical receivers 28, attached to tightening wheel 27, and bottom swivel 34, with swivel release 31, button. Electronics and wire connection box with wires 35, from foot 29, electrical receivers 28, connecting to electronics and wire connection box and electrical connections 45, in hot shoe 30, above swivel. Hinge 25, and hot shoe in upright position.

FIG. 10a Flash flip 24, with shoe and electrical receivers attached to tightening wheel and bottom swivel 34, with swivel release 31, button. Electronics and wire connection box with wires 35, from foot 29, electrical receivers 28, connecting to electronics and wire connection box and electrical connections 45, in hot shoe 30, above swivel. Hinge 25, and hot shoe 30, in left tilt position.

FIG. 10b Flash flip 24, with shoe and electrical receivers attached to tightening wheel 27, and bottom swivel 34, with swivel release 31, button. Electronics and wire connection box with wires 35, from foot 29, electrical receivers 28, connecting to electronics and wire connection box and electrical connections 45, in hot shoe 30, above swivel. Hinge 25, and hot shoe in right tilt position.

FIG. 11 Bottom of flash flip 24, with foot 29, tightening wheel 27, and electrical receivers 28.

FIG. 12 Top of flash flip 24, with hot shoe 30, tightening wheel 27, and electrical connections 45.

FIG. 13 Flash flip 24, with one release button to control tilt plus top and bottom swivel with rotating plate above hinge 25 with an outer casing 38.

FIG. 14 Flash flip 24, with tightening knob to control tilt and swivel actions on hinge 25.

FIG. 15 Flash flip 24, with ball head 40, hinge mechanism and flexible casing to allow tilt and swivel with a tightening knob 41. Lower swivel 26 and release button 31, with wires 35, coming out the side of the electrical connection boxes connecting from the foot 29, to the hot shoe 30.

FIG. 16 Flash flip 24, without tilt hinge and four swivels on top, bottom, left and right. Wires 35, from foot 29, are connected to hot shoes 30, on top, left and right.

FIG. 17 Clip on electrical connectors inside flash flip 24, connecting electrical contacts from foot 29, and hot shoe 30, to connecting wires.

FIG. 18A The camera 23H is horizontal with the flash flip device 48, tilted to the left which tilts the flash 21 L, horizontal above the left side of the camera.

FIG. 18b The camera 23H is horizontal with the flash flip device 47, straight up with the flash vertical above the camera.

FIG. 18c The camera 23H, is horizontal with the flash flip device 49, tilted to the right which tilts the flash 21R, horizontal above the right side of the camera.

FIG. 19a The flash flip device 48, tilted to the left.

FIG. 19b The flash flip device 47, in straight up position.

FIG. 19c The flash flip device 49, tilted to the right.

FIG. 20a The camera 23V, is vertical with the flash flip device 48, tilted to the left which places the camera shutter release button 42, at the top for a above the camera grip, and places the flash 20, in a vertical position above the lens and closer to it.

FIG. 20b The camera 23H is horizontal with the flash flip device 47, straight up with the flash vertical above the camera.

FIG. 20c The camera 23V, is vertical with the flash flip device 489, tilted to the right which places the camera shutter release button 42, at the bottom for a below the camera grip, and places the flash 20, in a vertical position above the lens and closer to it.

FIG. 21 The flash 20, attached to the flash flip device 47.

FIG. 22 The flash with the flash flip device built into it 46.

FIG. 23a The flash flip device 47 with a tightening wheel 27, to secure it to the camera.

FIG. 23b The flash flip device 47 with a tightening lever 18, to secure it to the camera.

FIG. 23c The flash flip device 47 with a tightening knob 17, to secure it to the camera.

FIG. 24a The camera 23H, horizontal with the flash flip device 47, swiveled so the flash can be tilted back to bounce off the ceiling.

FIG. 24b The camera 23H, horizontal with the flash flip device 47, swiveled so the flash can bounce off a wall. FIG. 25a The camera 23V, vertical with the lower swivel 33, on the flash flip device 48, available so the flash can be tilted back to bounce off the ceiling.

FIG. 25b The camera 23V, vertical with the upper swivel 31, on the flash flip device 48, swiveled so the flash can bounce off a wall.

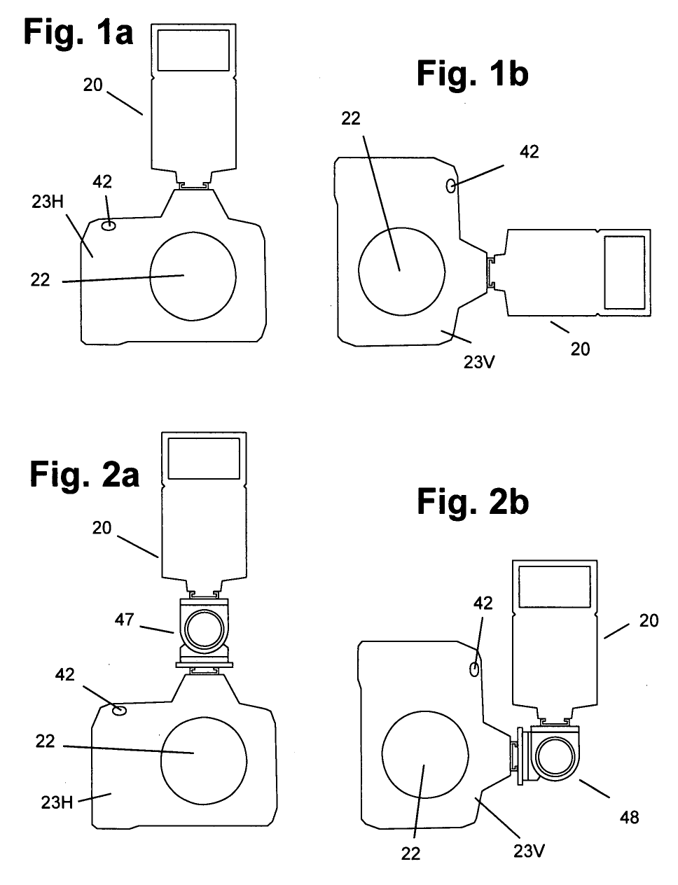

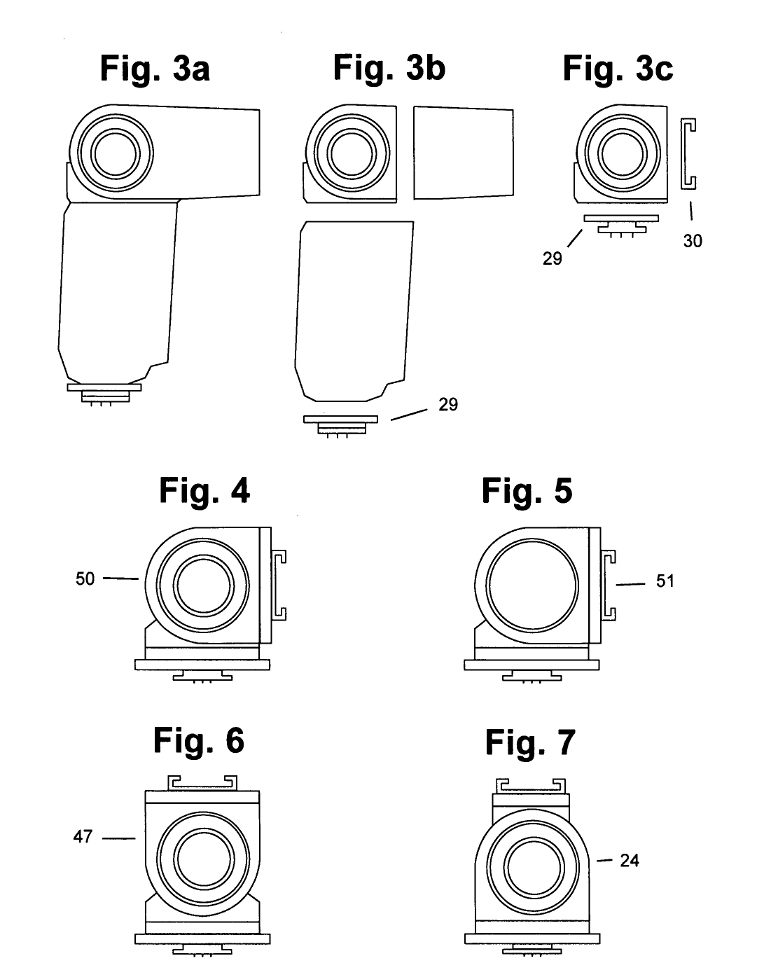

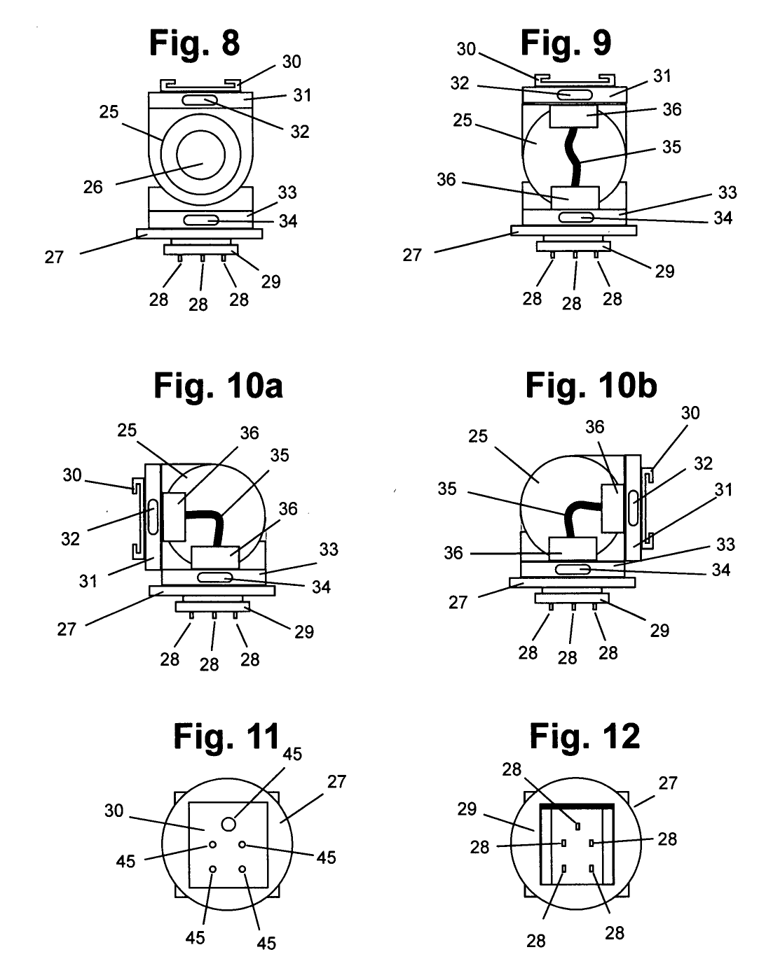

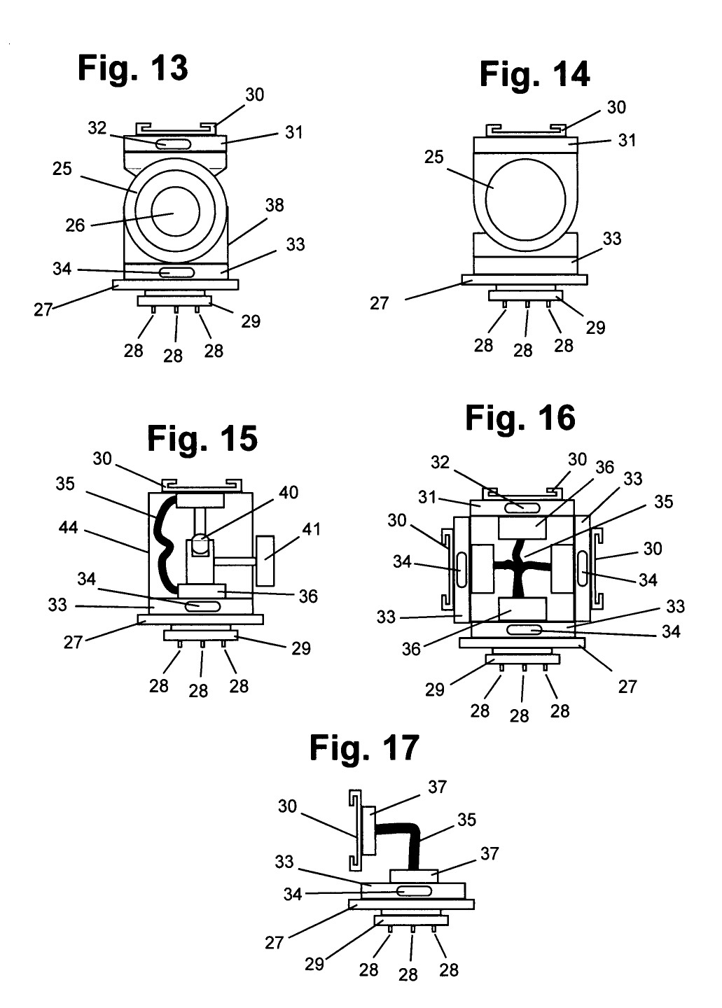

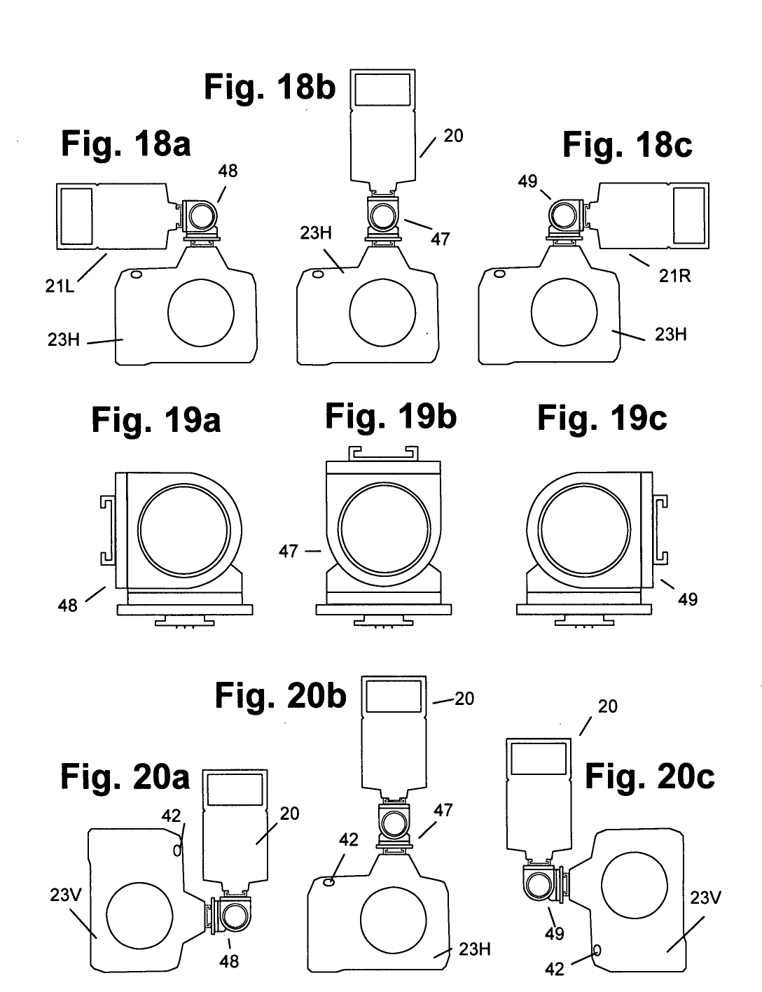

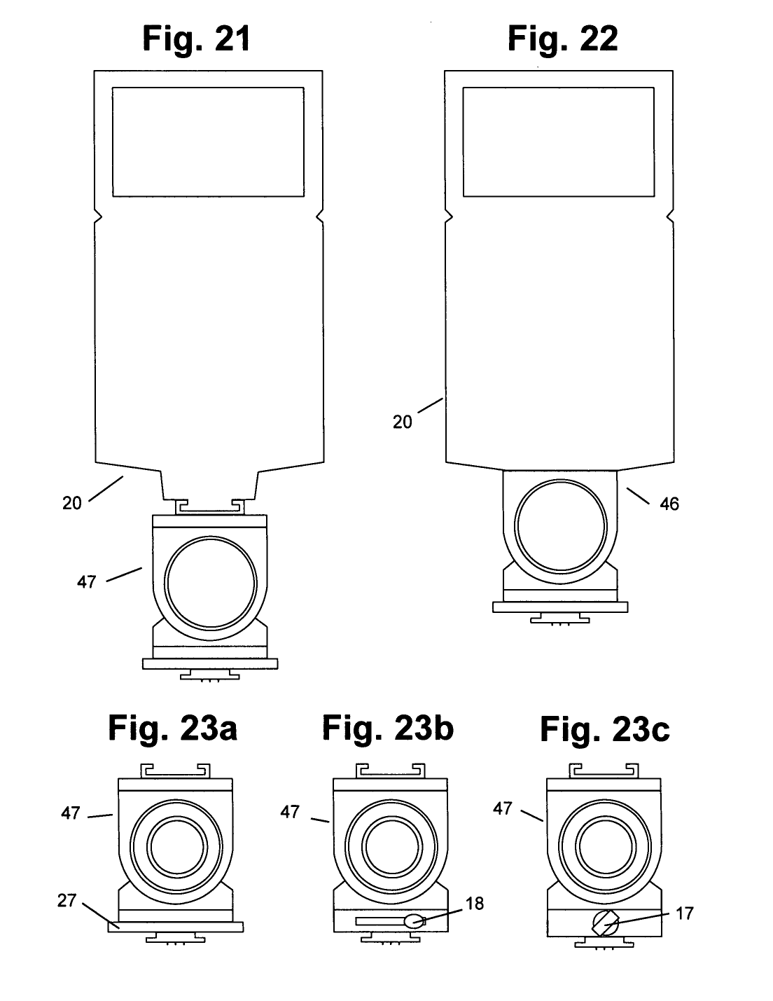

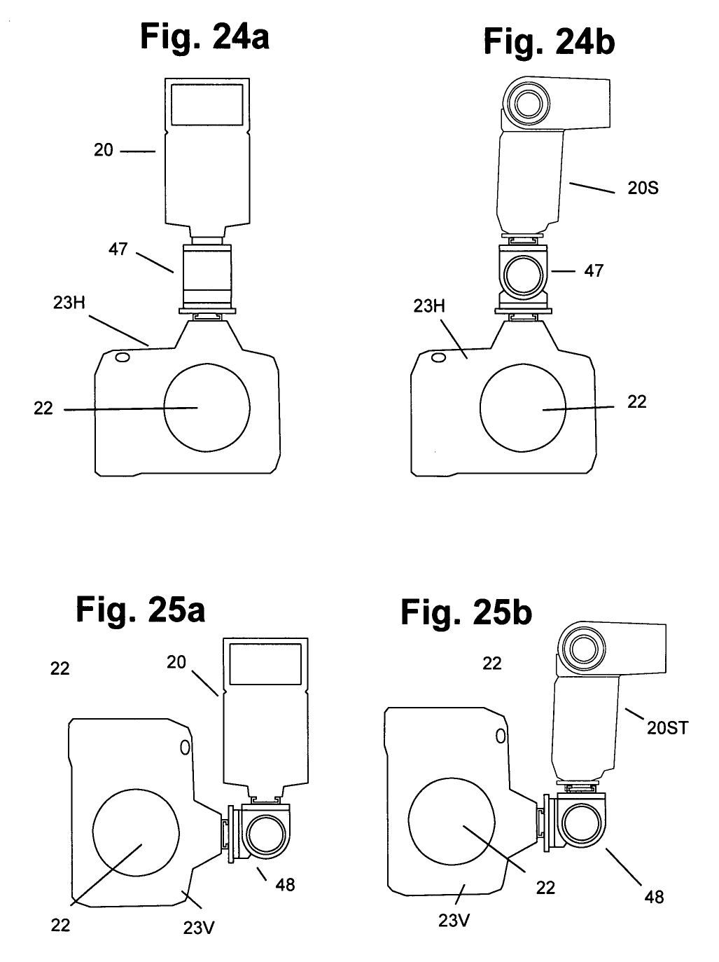

### DETAILED DESCRIPTION OF THE INVENTION

This invention allows the flash to be tilted up when the camera is in a vertical position bringing it above the lens and closer to it. The invention can be built into the flash or a separate device that is small and easy to fit in a camera case. It uses the hinge that has been used for years in flashes that allows them to tilt up and down with the wiring inside that communicates the information between the camera and flash. The independent device incorporates a flash foot and shoe just like the ones at the top of the camera and bottom of the flash to fit together. A locking mechanism such as a lock down wheel or a lever that are commonly used on flashes could be used to secure it. Pressing a button could release the tilting mechanism which would have stopping points just like the tilt mechanism and release flashes have built into them. The flash could tilt to the left or right to position the shutter release button above or below the camera and allow photographers the choice of holding their hand under or over the camera body.

I have invented a flash positioning device that allows a photographer to position the flash above the lens in a vertical camera position for more pleasing light. It also brings the flash closer to the lens for a smaller shadow behind the subject which is better. The flash flip has a foot that fits into the hot shoe on top of a camera. The top of the flash flip has a hot shoe the flashes foot can fit into.

The tilt hinge in the flash flip allows the flash to be tilted to the left and right. This allows the flash to be positioned above the lens on both the left and right side of the lens when the camera is in a vertical position. The advantage is that a photographer can position the flash on the opposite side of a second flash or light source as well as choosing how they want to hold the camera in a vertical position with their hand under or over the camera body.

The swivel hinges allow the photographer to swivel the flash to feather the light or bounce the flash off ceiling or walls even if the flash itself does not have a tilt or swivel mechanism built into it. Combining the flash flips movements with flashes that have tilt and swivel movements creates even more possibilities. The flash flip can be locked in place and released to reposition the flash with the push of a button in one embodiment. Click stops can be used to allow the flash to be quickly tilted at 45 and 90 degree angles as well as straight up and other settings. Other positions and methods of controlling the tilt and swivel can also be used such as a ratcheting system, tightening knob and ball head joint.

The flash flip hinge can be like the tilt cylinder hinge and swivel hinge that flashes use to allow the upper portion of the flash to tilt and swivel while allowing wires to go inside of them protecting the wires. The electrical contact points on the foot and hot shoe of the flash flip connect the camera to the flash with internal wiring. This allows the camera and flash to communicate and control the flash settings and exposure and lets it take advantage of through the lens metering as well as focusing distance based exposure calculations from the camera. The flash flip eliminates the need for an expensive TTL cord whose wires can get in the way and be damaged if pulled or snagged.

The flash position with the flip flash allows it to be used as direct flash as well as working with light modifiers like the Lumiquest bouncer.

The flash flip replaces two pieces of equipment and can fit into a photographers pocket or a small camera bag. A flash bracket and TTL cord are expensive and take up a lot of space in a camera bag.

Is more versatile, easier to handle and use than a flash bracket and TTL cord.

With its available adjustments and flash position above the lens the flash flip provides better main and fill light both indoors and outdoors using flash.

The flash flip can be produced to work with existing flashes and new flashes. The flash flip device can also be built into new flashes as a part of them. The flash flip can also be used with flash brackets to give more mobility to the flash when attached to them.

A breakaway plastic foot insures that if there is too much tension the flash flip foot with break first to prevent damage to the hot shoe on the top of the camera. The foot can also be made of metal or other materials.

The flash flip can be used with flash diffusers and bouncers and can be turned to feather the light to balance with existing light.

Small and light weight the flash flip is able to fit into a pocket. Packing light is important for professionals and amateurs who are buying a lot of digital SLR cameras and flashes. The new flashes are smaller and more powerful than earlier models and also take up less room in a camera bag. The trend is smaller is better.

The bottom of the flash flip has a flash foot that goes into the hot shoe on top of the camera.

The flash flip foot has electrical receptors that match the electronic connections in the cameras hot shoe.

The hinge allows the flash to tilt left and right to position the flash above the lens and closer to the lens when using a vertical camera position.

The hinge could have click stops to hold the flash in the chosen position and a release to release the hinge and allow the flash to be repositioned.

The top and bottom swivel mechanism can allow the flash to swivel in two different positions in addition to being tilted. The swivel release could be incorporated in the same button as the tilt or a separate release for both could be made.

Each of the electrical connections can be connected to a wire and these wires connected to the hot shoe on the top of the flash flip that the flash fits into.

A clip on connector can be used to connect inner wires between the flash flip foot to the flash flip hot shoe allows quick repair if the wires wear out.

A securing wheel can be tightened down to keep the flash flip firmly on the cameras hot shoe, but other methods to secure the flash can also be used.

The foot of the flash flip can be made of plastic to break off if there is too much pressure before any damage occurs to the cameras hot shoe.

The outer casing can protect the wires and hinge from snagging, dirt and water.

The user can put the flip flash in their pocket, and it takes up little space in a small camera bag where you could not get a flash bracket and TTL cord.

Simply slip the flash flip foot into the hot shoe on top of the camera and tighten down the securing wheel or other securing device.

Slip the foot of the flash into the hot shoe on top of the flash flip and tighten down its tightening wheel or securing device.

Press the release button to tilt or swivel the flash to the desired position and release the button to hold it there or use another release and hold device.

To get the flash above the lens in the vertical position, tilt the flash left or right.

Choose how you want to hold the camera with your hand underneath it and the shutter release below or your hand above the camera and the shutter release above and position the flash to allow this.

When the camera is in the vertical position the flash can be swiveled to bounce off the wall or the ceiling. The swivel allows the camera in horizontal position to bounce off walls.

Different materials, sizes and interconnections can be used for all components.

There are many possibilities for the hinge. A hinge can be used like the tilt cylinder hinge and swivel hinge that flashes use to allow the upper portion of the flash to tilt and swivel while allowing wires to go inside of them protecting the wires. The electrical contact points on the foot and hot shoe of the flash flip connect the camera to the flash with internal wiring.

A ball head with a tightening knob and the wires coming out the side of the foot and hot shoe and a flexible casing to protect the wires is an alternative way of making the flip flash. A ratcheting or tension device could also be used to position the flash.

A joint with the tilt and top and bottom swivel which can be used for other applications as well. Wireless transmitting of information from the camera to the flash could make the electrical connections and wiring unnecessary.

The wires could be attached to three hot shoes, one on the top, left and right in a non-moveable model where the flash would have to be moved from one to another hot shoe for positioning.

The flip flash could be created with the rounded edge up or down on top of the camera.

The flip flash could be created with no hinge and hot shoes on the top and sides where the flash would have to be detached and reattached to achieve the desired position.

It is evident that many alternatives, modifications and variations of the present invention will be apparent to those skilled in the art in light of the foregoing teachings. Accordingly, the invention is intended to embrace all such alternatives, modifications, and variations as may fall within the spirit and scope of ideas mentioned in this application.

Basics of using the apparatus
1. Slide the apparatus foot into hot shoe on camera.
2. Slide the flash foot into hot shoe on top of device.
3. Place camera in vertical position and tilt flash 90 degrees, by releasing apparatus and then securing it, so flash is above the lens and closer to the lens for better lighting and less shadow.
4. Flash can be tilted to the left or right to allow the photographer to choose a hand under or over grip on the camera.
5. Swivel flash on device to bounce flash off wall.

What is claimed is:

1. An apparatus that allows a flash to tilt to the left or right that positions the flash above lens and closer to lens when camera is in vertical position, comprising:
a hinge; wherein, said hinge includes:
a hot shoe on the top, a foot on the bottom and both having contact points with wires connecting them.
a release mechanism that releases the hinges position allowing it to move and and then locking mechanism that locks it into another position.
a locking mechanism that allows the bottom of the hinge and foot area to tighten onto the hot shoe area of the camera and hold it so it won't slide off.

2. The apparatus of claim 1, can be a separate device or built into a flash.

3. The apparatus of claim 1, attaches to the hot shoe on top of a camera with its foot and the flash attaches to the hot shoe on top of the apparatus.

4. The apparatus of claim 1, preferably is hollow inside so it can contain wires or other connecting devices to transfer information from the camera to the flash.

5. The apparatus of claim 1, will have a device to release it and lock it into place with possible click stops at but not limited to 0, 45, 90 degrees.

6. The apparatus of claim 1, swivel plate allows the flash to swivel to the left or right. The locking device for the swivel plate uses the same as the hinge or a separate release and lock device.

7. The apparatus of claim 1, has a locking mechanism to secure it to the camera hot shoe using a tightening wheel, lever, or other device.

8. The apparatus of claim 1, has connectors in the hot shoe and foot are manufactured to match the pattern of the camera hot shoe and the flash foot being used.

9. The apparatus of claim 1, wherein said wiring is preferably inside the hinge and connects the flash foot connectors to the hot shoe connectors.

10. The apparatus of claim 1, wherein said device foot attaches to hot shoe area on top of camera.
